(19) United States
(12) Patent Application Publication
(10) Pub. No.: US 2014/0274238 A1
(43) Pub. Date: Sep. 18, 2014

(54) System and Method for Harvesting and Processing Sugar-Containing Crops in the Field

(71) Applicant: LeeMax, LLC, Shawnee, OK (US)

(72) Inventors: Vincent E. Bernard, Cedar Falls, IA (US); Brian M. Balvin, Chelsea, IA (US)

(73) Assignee: LeeMax, LLC, Shawnee, OK (US)

(21) Appl. No.: 13/840,328

(22) Filed: Mar. 15, 2013

(51) Int. Cl. A01D 91/04

(52) U.S. Cl. CPC A01D 91/04
USPC 460/123; 460/149

(57) ABSTRACT

A mobile field harvesting process for harvesting and further processing sugar-containing crops, such as sweet sorghum, includes cutting the crop, chopping the crop, and reducing the crop to the crop's separated juice and solids in the field. Separation is carried out using a chopper and a juicer. The juicer may be a screw press. The juice may be stored and fermented on the farm, followed by distillation by a mobile distillation process to separate the alcohol from the stillage.

### BACKGROUND OF THE INVENTION

1. Field of the Invention

The present invention relates generally to a system and method of harvesting and processing sugar-containing crops such as sweet sorghum. More particularly the present invention relates to a mobile harvester for cutting and processing sweet sorghum in the field to yield its juices, and then to further process the juice via fermentation and distillation to produce ethanol.

2. Background

Traditionally, sweet sorghum has been harvested for sorghum syrup production by either cutting and handling the stalks by hand, or by chopping the stalks and blowing the chop into a forage wagon; in either case, the resulting plant matter is carried to a central processing station for the extraction of the juices, cooking and reduction of the juices to sorghum syrup.

The former method requires a large expenditure of manual labor and is typically used in small, such as family sized operations. The juice from the stalks is often squeezed using a single-roller press powered by a horse, mule, or lawn tractor.

The method of chopping the stalks in the field like ensilage is less labor intensive than the previously mentioned method and larger crops may be harvested and processed this way. The drawbacks of this method, however, include: an enormous amount of crop must be transported out of the field to a central processing location, and the resultant organic matter must then be either returned to the field or otherwise disposed of.

Another former system for processing sweet sorghum focused on the use of a roller press incorporating multiple rollers. However, roller presses alone may be an inefficient means to extract juice from a sugar-producing crop.

Energy is a matter of concern to the country, and will continue to be for some time. Air pollution has improved over the past several decades, but still remains an issue in parts of this country, as well. A recognized partial solution to both the energy and pollution problems is ethanol. Sweet sorghum juice, due to its high sugar content, is an ideal raw material for the production of ethanol. Sweet sorghum has the potential to produce over twice the ethanol per acre as corn, the most common raw material used for ethanol production, today, at significantly less cost. As it stands presently, a more efficient method of harvesting the sorghum crop must be employed to make the use of this crop for ethanol production feasible.

There is, therefore, a need for a low-labor, efficient process for harvesting and field processing sweet sorghum and extracting the juices for further processing at or near the fields of each producer.

### SUMMARY

A purpose of this invention is to provide a system and process for field harvesting and processing sweet sorghum crops and extracting the juices for further processing. Another purpose of this invention is to provide a process for fermenting sugar rich substances such as sweet sorghum juice, ultimately for its ethanol. Still another purpose is to provide a portable process for distilling the ethanol from the fermented juice, also referred to herein as wine.

In general, a field harvesting process for a sugar-producing crop, such as sweet sorghum, is initiated by cutting the stalks of the sugar-producing crop close to the ground in the field and then feeding the stalks to a mobile chopper assembly adapted to chop the stalks of the sugar-containing crop into segments in a field. The segments may have a length less than six inches in length, and preferably, less than one and a half inches in length. The segments are then fed into a mobile juicer coupled to the mobile chopper assembly. The segments have juice encapsulated within fibers. The mobile juicer may extract the juices from the fibers of the segments of the sugar-containing crop in the field. The juices may then be captured by a mobile container adjacent to the mobile juicer for collecting the extracted juices from the mobile juicer in the field. The juice may be pumped or gravity-fed into a storage unit that is also preferably in the field.

The present disclosure also describes a fermentation process, which takes place within the storage units in a matter of days, and a portable distillation process to recover the ethanol from the resultant wine and to concentrate this ethanol to a suitable concentration for use as fuel ethanol. It should be understood that tanks for storage and fermentation may take many forms. For example, stationary, rigid tanks and/or portable bladders may be used. In either case, a vent for permitting the release of Carbon Dioxide (CO₂) gas may be used during the fermentation process.

A portable distillation process, for example, mounted on a “low-boy” type truck or semi-trailer, may be used to concentrate the ethanol to a fuel level. The distillation process may use fossil fuel(s) for the heat required, but an aspect of the present disclosure is to gasify the solid crop material or bagasse for the heat needed for distillation. A distillation process may comprise a heating unit in which the fermented juices (wine) are heated so the alcohol will evaporate at about 180° F.; a condensing unit in which the alcohol is cooled so it condenses; and a molecular sieve unit in which distilled alcohol is concentrated to fuel grade.

The novel features which are believed to be characteristic of this invention, both as to its organization and method of operation together with further objectives and advantages thereto, will be better understood from the following description considered in connection with accompanying drawings in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 depicts a partial cross-section side view of an exemplary field harvester.

FIG. 2 depicts a top view of the exemplary field harvester of FIG. 1.

FIG. 3 depicts a partial cross-sectional diagram of an exemplary mobile juicer implemented as a conically shaped screw press in accordance with the present disclosure.

FIG. 4 depicts a diagrammatic, partial cross-section of another exemplary mobile juicer implemented as a cylindrical screw press in accordance with the present disclosure.

FIG. 5 depicts a partial cross-sectional side view sketch of another embodiment of an exemplary field harvester having multiple stages of juicers in accordance with the present disclosure.

FIG. 6 depicts a front view of exemplary segmented roller pairs in accordance with the present disclosure.

FIG. 7 depicts a cross-sectional view of a segmented roller and a roller drive shaft in accordance with the present disclosure.

FIG. 8 depicts an exemplary self-propelled field harvester in accordance with the present disclosure.

FIG. 9 depicts a flow chart of an exemplary mobile distillation process in accordance with the present disclosure.

FIG. 10 depicts a schematic of an exemplary mobile distillation process in accordance with the present disclosure.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Referring now to the drawings, FIGS. 1 and 2 depict an exemplary mobile field harvester 100 in accordance with the present invention. In particular, FIG. 1 is a partial cross-sectional side view of the exemplary field harvester 100. FIG. 2 is a top view of the exemplary field harvester 100 of FIG. 1. In one embodiment, the field harvester 100 is depicted as a pull-behind unit with at least two wheels 101 powered through a power take off (not shown); however it should be understood that the field harvester 100 may have any number of wheels and/or tracks and may be powered in any manner and/or may be a self-contained vehicle unit such as a combine. The mobile field harvester 100 may be used for any sugar-containing crop, for example, sweet sorghum, switch grass, and/or sugar cane.

In general, the exemplary field harvester 100 may comprise a mobile chopper assembly 104, a mobile juicer 106, and a mobile container 108 for collecting the juices. In one embodiment, the field harvester 100 may also comprise a mobile frame 110 which may support a crop cutter assembly 112, a crop mover assembly 114, a chopper feeding unit 116, the chopper assembly 104, the juicer 106, and the container 108.

More specifically, the frame 110 may have a front end 118 and a back end 120, as illustrated in FIG. 2. The crop cutter assembly 112 may have at least one moveable cutter blade 113 for separating the sugar-containing crop from its roots. The at least one crop cutter blade 113 may be rotatable, for example, the at least one crop cutter blade may be attached to at least one cutter rotor 121. The crop cutter assembly 112 may be operatively attached to the front end 118 of the frame 110 and sized to cut one or two rows of the sugar-containing crop, as illustrated in FIG. 2, or may be sized appropriately to cut one or more rows based on the planting scheme of the sugar-containing crop. For example, the crop cutter assembly 112 may cut a dozen rows or more in one pass of the field harvester 100.

The crop mover assembly 114 may grab and move the sugar-containing crop from the crop cutter assembly 112 to, for example, the chopper feeding unit 116. The rate of movement may be controllable, for instance, mechanically or by electronic control. In the example illustrated in FIGS. 1 and 2, the crop mover assembly 114 comprises two gathering screws 122 and at least one support belt 124. The support belt 124 may assist the gathering screws 122. For example, the support belt 124 may assist in rotating the stalks of the sugar-containing crop. The support belt 124 may be run at a rate of speed faster than the ground speed of the field harvester 100. For example, the support belt 124 may run at four feet per second while the field harvester 100 may run at three feet per second, thus rotating the stalks. Of course, it should be understood that the crop mover assembly 114 may contain any variety of crop moving devices, and may be scaled to the number of crop rows being harvested in one pass by the mobile field harvester 100. For example, the crop mover assembly 114 may comprise one or more conveyor belts or pneumatic conveyors.

FIG. 1 illustrates an exemplary embodiment of the chopper feeding unit 116. The chopper feeding unit 116 may have an inlet for receiving the sugar-containing crop from the crop cutter assembly 112, and an outlet to discharge the sugar-containing crop to the chopper assembly 104, for example. In one example, the stalks of the sugar-containing crop are rotated toward the chopper feeding unit 116, for instance, by the support belt 124 in the crop mover assembly 114. The chopper feeding unit 116 may be designed to grip and move the sugar-containing crop into the inlet of the chopper assembly 104. The rate of movement may be controllable, for instance, mechanically or by electronic control. In this example, the chopper feeding unit 116 is comprised of two nip rollers 126 which channel the sugar-containing crop to the chopper assembly 104. The nip rollers 126 may have one or more protrusions 128 to help grip and move the sugar-containing crop. In one aspect of the invention, the chopper feeding unit 116 may be comprised of multiple rollers, or at least two conveyors adapted to move the sugar-containing crop between the at least two conveyors.

The chopper assembly 104 is adapted to chop the sugar-containing crop in the mobile field harvester 100 while in the field. Typically, the chopper assembly 104 may have an inlet for receiving the sugar-containing crop and an outlet for discharging chopped segments of the sugar-containing crop. In one aspect of the invention, the chopper assembly 104 may comprise at least one chopper blade 138 and a chopper anvil 140. The chopper anvil 140 may be manually adjustable, or automatically self-adjustable to allow for various diameters of stalks of the sugar-containing crop. In one example, the at least one chopper blade 138 is moveable in a rotary fashion to chop the sugar containing crop into segments. The at least one chopper blade 138 may be attached to, or part of, chopper rotor 144. In one example, the chopper feeding unit 116, such as nip rolls 126, may force the stalk of the sugar-containing crop into the chopper assembly 104, where the stalk is fractured between the chopper blade 138 attached to the chopper rotor 144 and the anvil 140. The rotation of the chopper rotor 144 may carry the resulting segment of stalk toward the outlet of the chopper assembly 104.

In one example, additional chopper blades 138 and/or additional chopper assemblies 104 may be used to chop the stalks into segments. The stalks may be segmented into any size, however, for efficiency the chopper assembly 104 may be adapted to segment the stalks into pieces less than six inches in length, and preferably, less than one and a half inches in length. In one example, the chopper assembly 104 segments the stalks into segments from one (1) to one and a half (1.5) inches in length. The chopper assembly 104 may chop the stalks into smaller segments by increasing the speed of the at least one chopper blade 138, for example.

The mobile juicer 106 may receive the segments of the stalks of the sugar-containing crop and extract juices from the segments, and may discharge the extracted juices to the container 108. The juicer may be driven by a reversible drive 148, for example. In one embodiment, the mobile juicer 106 may be a screw press 150 as depicted in FIGS. 1, 2, and 3. FIG. 3 is a depiction of a partial cross-section of the exemplary screw press 150 in accordance with the present disclosure. In this example, the screw press 150 is a conical shaped screw press 150a, having a first end diameter at an inlet that is larger than a second end diameter at an outlet. In other words, the screw press 150 may have an inlet for receiving the chopped segments of the sugar-containing crop from the chopper assembly 104 in the first end of the screw press 150.

The screw press 150 may include a screw 152, such as conical screw 152a, having a rotatably drivable internal shaft 154, inside a housing 156, such as conical housing 156a. The screw 152 may be rotatable by the shaft 154 inside the housing 156 such that the segments of the sugar-containing crop are moved and compressed from the first end to the second end of the screw press 150 to extract the juice. The screw 152 may have variable pitch between the first end and second end such that the pitch is smaller toward the second end of the screw 152. In one example, the shaft 154 may be supported by a bearing 158, such as nose bearing 158a. The housing 156 may be fitted to the screw 152 to prevent the segments from escaping when moved and compressed by the screw 152 between the first end and the second end of the screw press 150. The conical shape of conical screw 152a and conical housing 156a may allow for adjustment of a gap between the screw 152 and the housing 156. For example, in cases of wear of the screw 152a and/or housing 156a, the conical screw 152a may be moved axially along the shaft 154 toward the smaller second diameter of the housing 156a, thus decreasing the gap between the screw 152a and the housing 156a.

The housing 156 may be perforated such that the housing 156 is permeable by the extracted juice, while containing the fibrous material of the segments of the sugar-containing crop between the first end and the second end of the screw press 150 in the housing 156. In one example, the housing perforations are slanted bores 160 running through the housing 156 and angled in a direction away from the movement of the segments through the screw press 150, also referred to herein as “back slant.” The back slant of the bores 160 may reduce clogging of the bores 160 by fibrous material of the segments of the sugar-containing crop.

The screw press 150 may have an outlet 162 on the second end of the screw press 150 for discharging the chopped and squeezed fibrous material of the segments, also referred to herein as “bagasse.” In one embodiment, the pressure of the screw press 150 on the segments of the sugar-containing crop may be adjustable, for example, by utilizing an adjustable choke 164. The position of the choke 164 relative to the housing 156 may be adjusted to narrow or increase the outlet 162 such that the back-up of the fibrous material of the segments between the screw 152 and the choke 164 causes more pressure to be applied to the segments.

In one embodiment, the fibrous material of the segments (the bagasse) may be discharged from the outlet 162 to a reversible trash screw 170. The trash screw 170 may discharge the fibrous material to the field or may discharge the fibrous material to a storage unit (not shown). Of course, other types of movers may be used to convey the fibrous material away from the outlet 162, for example, one or more mechanical or pneumatic conveyors.

In one embodiment, the field harvester 100 may also comprise a pump to pump the juice from the container 108. The juice may be pumped to a juice storage tank. For example, the juice storage tank may be a pull-behind mobile tank pulled by, or with, the field harvester 100. In one example, the juice storage tank is a separate mobile tank not attached to the field harvester 100. In another example, the juice storage tank may be immobile.

FIG. 4 depicts a cross-sectional sketch of an exemplary screw press 150b in accordance with the present disclosure. In one embodiment, the screw press 150b is cylindrical in shape, including the screw 152b and housing 156b, with the first end diameter and the second end diameter being approximately the same size. In the example of FIG. 4, the screw 152b is of variable pitch between the first end and second end such that the pitch is smaller toward the second end of the screw 152b. The screw 152b has a plurality of flights that define a helical passage from the first end to the second end. Because the screw 152b has a variable pitch, the distance between adjacent flights decreases towards the second end. Because the volume between the flights is dependent upon the distance between the flights, the volume between the flights decreases towards the second end. Thus, as the segments are conveyed from the first end to the second end, the volume of the segments is reduced thereby forcing the juice out of the segments.

The internal shaft 154 may be supported by end bearing 158b and driven by the reversible drive 148. The reversible drive 148 may allow the rotation of the screw 152 be reversed, for example, to relieve pressure in the screw press 150.

In one embodiment, the mobile field harvester 100 may comprise additional juicing components. For example, FIG. 5 depicts a partial cross-sectional side view sketch of exemplary field harvester 100a in accordance with the present disclosure in which the field harvester 100a further comprises a roller press assembly 200 for extracting juice from the sugar-containing crop. The roller press assembly 200 may be located before the chopper assembly 104. The roller press assembly 200 may receive the sugar-containing crop via an inlet and discharge the pressed crop via an outlet. The roller press assembly 200 may comprise one or more roller sets 210. In one example, the roller sets 210 may comprise one or more of a plurality of segmented roller pairs 212, each roller pair 212 having a first segmented roller 216 and a second segmented roller 218 aligned with one another such that a gap is created between the outer diameters of the first and second segmented roller 216, 218. The sugar-containing crop may pass in the gap between the segmented rollers in the roller pairs in succession, thus squeezing juice from the sugar-containing crop. The extracted juice may be captured by the container 108.

FIG. 6 depicts a front view of exemplary segmented roller pairs 212 in accordance with the present disclosure. The segmented roller pairs 212 may be adapted to allow for pressure to be exerted on different diameter stalks of the sugar-containing crop. For example, if stalks that are of a wider diameter than the size of the gap between the segmented rollers 216 and 218, then one or both of the segmented rollers 216 and 218 may move, widening the gap and allowing the thicker stalks to pass through while maintaining pressure on the stalks.

In one embodiment, the segmented rollers 216, 218 are self-adjustable. For example, FIG. 7 depicts a cross-sectional side view of a self-adjustable segmented roller 216 and a roller drive shaft 220 in accordance with the present disclosure. In this example, between the internal diameter of the segmented roller 216 and the roller drive shaft 220, there may be a layer of compressible material 222. In this way, if a stalk of the sugar-containing crop that has a larger diameter than the gap between the segmented rollers 216, 218 goes between the segmented rollers 216, 218, the compressible material 222 allows the segmented roller 216 to move slightly, that is move by the amount of the compression of the compressible material 222. Then the compressible material 222 may return to its previous uncompressed dimension. One example of the compressible material 222 is high durometer rubber. In one example, the compressible material 222 may be chosen for properties that allow for compression based on a required pressure, so as to maintain a minimum pressure on the stalks of the sugar-containing crop to extract juice.

FIG. 8 depicts one embodiment of an exemplary self-propelled field harvester 100b which is similar in construction to the harvester 100a with the exception that the harvester 100b is self-propelled. The self-propelled field harvester 100b may be powered by an engine 360, such as a diesel engine, rather than drawn by a tractor, for example. The harvester 100b may be operated from a cab 365. The crop cutter assembly 112 and crop mover assembly 114 may be carried on the front of the field harvester 100b where the crop is sheared from the ground and transferred to the mobile juicer 106, such as roller press assembly 200 and/or screw press 150. In one embodiment the solids (i.e. the bagasse) leaving the screw press 150 may be made into pellets in a rotary ring pelletizing process unit 350 and transported to storage. The pellets may be used for fuel for alcohol distillation, for livestock feed or for other purposes. Of course, it should be understood that the solids may instead be converted into other, marketable products.

A pH adjustment of the juices is carried out, if necessary before or as the juices are pumped to the storage tank 370. A tank for acid 380 for adjusting the pH of the juice to about 4.5-4.8 may be carried in front of a water tank 385. In this example, the extracted juices may pass to an optional pH adjustment unit 335 where the pH may be measured and adjusted to about 4.5-4.8 to inhibit bacterial action. If the final product is to be lactic acid or some other products, this step may be unnecessary. The juices may then be stored for fermentation and subsequent distillation. Yeast may be introduced on board the harvester 100b. The juices may be filtered in filtering unit 390.

After the sweet sorghum crop has been processed into its juices in the field harvester 100, the juices may be further processed into a useable and saleable product. Other aspects to the present invention include further storage and processing including fermentation and distillation.

FIG. 9 depicts an exemplary process 600 in accordance with the present invention. In one embodiment, the juices from the field harvester 100 may be transferred into storage/fermentation tanks 605. During transfer from the field harvester 100, selected yeasts may be added. The fermentation tanks 605 may take many forms, for example, rigid, stationary tanks and/or portable, fiber elastic bladders. The fermentation process typically lasts for a few days. Throughout fermentation, CO₂ is produced. Irrespective of the form of the storage/fermentation tanks 605, the fermentation tanks 605 typically have a vent 610 for venting the CO₂ produced by the yeast during fermentation. The CO₂ may be captured for sale.

The fermented juices (wine) laden with ethanol may be transported or transferred from the storage/fermentation tanks 605 under gravity or with a wine pump 615 into a wine tank 620. From the wine tank 620, the wine may be transported under gravity or by a distillation pump 625 into a distillation boiler/column 630. In the distillation column 630, the alcohol may be separated from the remainder of the wine, or stillage. The resulting low-grade alcohol may be further cooled in a heat exchanger 635 used to preheat the wine before being further refined in a molecular sieve stripping unit 665. This final product fuel ethanol may then be loaded into a tank for storage or transport.

Heat for the distillation column may be provided by heating water in a boiler 640. The fuel 645 for the boiler may be Liquid Propane (LP), or other fossil fuel, or the bagasse (the solids left over after removing the juice from the sugar-producing crop, such as sweet sorghum) may be put through the process of gasification, and the resulting fuel 645 burnt to heat the boiler 640. The heat from the bagasse burning can also be used in the distillation process.

Gasification of a carbonaceous material such as bagasse results in a fuel referred to as producer gas. The combustible components are, largely, carbon monoxide (CO) and hydrogen (H₂).

Steam, from the boiler 640, may first travel to the distillation column 630. From the distillation column 630, the condensate may be used in the line from the wine tank 620 to preheat the wine before distillation. A wine tank heat exchanger 650 in the wine tank 620 may impart the heat to the wine. From the wine tank 620, the condensate may move to a condensate holding tank 670. The condensate may be finally returned to the boiler through a boiler feed pump 660. A heat transfer fluid may also be used, instead of steam, to transfer heat for the distillation process.

FIG. 10 depicts an example of a portable part of the distillation process 600 (also inside the heavy dot-dashed line in FIG. 9). In this case, the distillation column 630, with its heat exchanger 635, the boiler 640, condensate holding tank 670, the wine tank 620, the molecular sieve stripping unit 665, associated pumps 615, 625, the boiler feed pump 660, and associated controls are carried on a semi-trailer 700. It should be understood that other combinations are also possible. The semi-trailer 700 may carry the distillation process 600 to the field where the sugar-containing crop is being harvested by the field harvester 100.

The above embodiments are the preferred embodiments, but this invention is not limited thereto. Many of the elements of the process mentioned, above, are optional, providing for a large degree of flexibility and pricing. It is, therefore, apparent that many modifications and variations of the present invention are possible in light of the above teachings. It is, therefore, to be understood that within the scope of the appended claims, the invention may be practiced otherwise than as specifically described.

1. A mobile field harvester, comprising:
a mobile chopper assembly adapted to chop a sugar-containing crop in a field, the chopper assembly having an inlet for receiving the sugar-containing crop and an outlet for discharging chopped segments of the sugar-containing crop;
a mobile juicer receiving the segments of the sugar-containing crop and extracting juices from the segments of the sugar-containing crop in the field; and
a mobile container adjacent to the mobile juicer for collecting the extracted juices from the mobile juicer in the field.

2. The mobile field harvester of claim 1, further comprising
a frame having a front end and a back end, the back end being fixed with respect to the front end;
a crop cutter assembly having a moveable cutter blade for separating the sugar-containing crop from its roots, the crop cutter assembly operatively attached to the front end of the frame;
a crop mover assembly adapted to move the sugar-containing crop from the crop cutter assembly at a controllable rate; and
a chopper feeding unit having an inlet and an outlet, wherein the sugar-containing crop from the crop mover assembly is receivable by the chopper feeding unit through the inlet and is moveable through the chopper feeding unit and out of the outlet at a controllable rate to the mobile chopper assembly.

3. The mobile field harvester of claim 2, further comprising at least two wheels operatively and rotatably attached to the frame for facilitating movement of the mobile field harvester along a ground surface.

4. The mobile field harvester of claim 2, wherein the crop mover assembly comprises at least two gathering screws.

5. The mobile field harvester of claim 2, wherein the chopper feeding unit comprises at least two nip rollers.

6. The mobile field harvester of claim 1, wherein the mobile juicer comprises a screw press assembly comprising:
a screw having a rotatably drivable internal shaft, the screw rotatable by the shaft such that the segments are moved and compressed to extract juice; and
a housing disposed about the screw, the housing having a first end and a second end and an internal diameter from the first end to the second end, the housing fitted to the screw to prevent the segments from escape when moved and compressed by the screw between the first end and the second end, the housing being perforated such that the housing is permeable by the extracted juice, the housing having an inlet in the first end to receive the chopped segments from the chopper assembly and an outlet in the second end for discharging the chopped and squeezed segments.

7. The mobile field harvester of claim 6, wherein the screw is conical shaped and the housing has a corresponding conical shape, wherein the first end of the housing is larger than the second end of the housing.

8. The mobile field harvester of claim 6, further comprising:
a roller press assembly for extracting juice from the sugar-containing crop, the roller press assembly having an inlet and outlet and comprises a plurality of segmented roller pairs, each roller pair having two segmented rollers aligned with one another, whereby the sugar-containing crop is received via the inlet, passed through and pressed between the segmented roller pairs, and whereby the pressed sugar-containing crop is discharged via the outlet to the screw press assembly; and
wherein the segmented roller pairs self-adjust to diameters of stalks of the sugar-containing crop.

9. The mobile field harvester of claim 1, wherein the chopper assembly comprises at least one chopper blade movable past an anvil.

10. The mobile field harvester of claim 1, further comprising:
a juice storage tank; and
a pump operatively positioned to transfer juice from the container to the juice storage tank.

11. A method for harvesting sugar-containing crops with a mobile field harvester, the method comprising the steps of:
cutting a sugar-containing crop from the sugar-containing crop roots in a field utilizing a crop cutter assembly;
moving the sugar-containing crop from the crop cutter assembly at a controllable rate to a chopper assembly;
chopping the sugar-containing crop with the chopper assembly into a plurality of segments;
extracting juice from the plurality of segments with a screw press assembly; and
capturing in a container the extracted juice from the screw press assembly.

12. The method for harvesting sugar-containing crops with a mobile field harvester of claim 11, further comprising the steps of:
moving the extracted juice from the container to a juice storage tank;
fermenting the extracted juice into wine in the juice storage tank; and
distilling the wine to separate the alcohol from the wine in a distillation column.

13. The method for harvesting sugar-containing crops with a mobile field harvester of claim 12 wherein the steps of fermenting the extracted juice and distilling the wine take place in a field.

14. The mobile field harvester of claim 10, wherein the extracted juice is fermented into wine in the juice storage tank, and further comprising a distillation column wherein the wine is distilled to separate the alcohol from the wine.

15. The mobile field harvester of claim 14, wherein the juice storage tank and the distillation column are located in a field.
